(19) United States
(12) Patent Application Publication
(10) Pub. No.: US 2013/0131562 A1
(43) Pub. Date: May 23, 2013

(54) MASSAGE DEVICE

(71) Applicant: Dong-Her Wu, Pu Yen Hsiang (TW)

(72) Inventor: Dong-Her Wu, Pu Yen Hsiang (TW)

(21) Appl. No.: 13/303,225

(22) Filed: Nov. 23, 2011

(51) Int. Cl. A61H 15/00

(52) U.S. Cl. 601/112

(57) ABSTRACT

A massage device includes a rotation member and a massage head seat. The rotation member includes a driving axle at an upper end thereof to connect an eccentric rotation disc. A motor is to drive an axle of the eccentric rotation disc. A rivet is inserted in a through hole of a rotation post and pivoted to a hole of the eccentric rotation disc. The hole is disposed at an eccentric position of a top end of the eccentric rotation disc. The rotation post is secured in a link post at one end of the massage head seat.

### BACKGROUND OF THE INVENTION

1. Field of the Invention

The present invention relates to a massage device, and more particularly to a massage device having an eccentric rotation disc coupled to a massage head seat for massage.

2. Description of the Prior Art

As shown in FIG. 6, a conventional massage device is invented by the applicant of this application and allocated Taiwanese patent application No. 93207161. The massage device comprises a crank 8 which has a fixing portion 81 coupled to an axle 71 of a rotation member 7. The crank 8 is driven by a motor in the rotation member 7. A pivot portion 91 is connected to the central bottom of a massage head seat 9. The crank 8 has a protruding shaft 82 which is pivoted to the pivot portion 91. When the rotation member 7 is activated, the crank 8 and the massage head seat 9 will be eccentrically turned. However, the assembly of the rotation member 7, the crank 8 and the massage head seat 9 needs auxiliary parts. The cost is high and it consumes labor for assembly. The massage head seat 9 is not at a fixed angle relative to the contact surface, which results in a deflection stress of the crank 8. The massage is not even. Sometimes, the deflection stress is too large to stop the operation of the massage device because the rotation force is not enough.

Taiwanese patent application Nos. 97220370 and 98204323 are also invented by the applicant of this application. As shown in FIG. 7, another conventional massage device comprises a rotation member 4. The rotation member 4 has a driving post 41 extending from a motor which is disposed in the rotation member 4. The driving post 41 has four grooves and a resilient section between the grooves. The resilient section has an engaging rib protruding from an end thereof. A rotation disc 5 and a massage head seat 6 have a first annular wall 51 and a second annular wall 62 to engage with each other. The rotation disc 5 and the massage head seat 6 further have a link trough 52 and a massage surface 62 at opposing ends thereof. The link trough 52 is disposed at an eccentric position of the rotation disc 5, and has driving ribs to mate with the grooves. The link trough 52 further has an engaging portion for engagement of the engaging rib. The driving post 41 drives the rotation disc 5 to turn in an eccentric way, and the massage heat head 6 is also turned for massage. If the rotation disc 5 is big, the sway may be too large and it is not easy to hold the massage device. If the rotation disc 5 is small, the sway may be too small and the range of rotation is also small. The driving post 41 is subject to the diameter of the rotation disc 5. If the diameter of the driving post 41 is too small, the force of rotation is not enough.

In addition, the crank 8 driven by the motor and the driving post 41 of the aforesaid two massage devices are coupled to the massage head seat 9 and the rotation disc 5 in an exposed way. The hair may be sucked in the massage device.

Accordingly, the inventor of the present invention has devoted himself based on his many years of practical experiences to solve these problems.

### SUMMARY OF THE INVENTION

The primary object of the present invention is to provide a massage device which comprises a rotation member and a massage head seat. The massage head seat comprises a link post at one end thereof. The link post has a link trough therein and is coupled to a rotation post of the rotation member. The rotation post has at least two spaced grooves and a resilient section between the two grooves. The resilient section has an engaging rib protruding from an end thereof. The link trough has ribs corresponding to the grooves and an engaging portion which has a larger diameter to position the engaging rib. The rotation member comprises a driving seat at an upper end thereof. The driving seat comprises a driving axle which extends from a motor disposed in the driving seat. The driving seat has an opening which faces upward to receive an eccentric rotation disc. The eccentric rotation disc has a central axle which is connected to the driving axle of the driving seat. The eccentric rotation disc further has a hole at a circumferential portion thereof. A rivet is inserted in a through hole of the rotation post and pivoted to the hole of the eccentric rotation disc to secure the rotation post at an eccentric position of the eccentric rotation disc. The massage head seat further comprises a massage surface at another end thereof. The eccentric rotation disc is pivotally connected to the driving seat. The motor drives the eccentric rotation disc to turn through the driving axle so that the rotation post is turned in an eccentric way. The rotation post is driven to pivot in the hole through the rivet to enhance rotation torsion.

Preferably, the eccentric rotation disc further has an annular protection board on a top surface thereof to surround and protect the rotation post, and the link post has an annular groove which is disposed at an edge of the link post and fitted on top of the protection board.

### BRIEF DESCRIPTION OF THE DRAWINGS

FIG. 1 is an exploded view according to a preferred embodiment of the present invention;

FIG. 1-A is a rear side view showing the eccentric rotation disc according to the preferred embodiment of the present invention;

FIG. 2 is a perspective view according to the preferred embodiment of the present invention;

FIG. 3 is a sectional view according to the preferred embodiment of the present invention;

FIG. 4 is a perspective view showing the rotation member according to the preferred embodiment of the present invention;

FIG. 4-A is a schematic view showing rotation of the rotation member according to the preferred embodiment of the present invention;

FIG. 5 is a perspective view showing different massage head seats according to the preferred embodiment of the present invention;

FIG. 6 is an exploded view of a conventional massage device; and

FIG. 7 is a sectional view of another conventional massage device.

### DETAILED DESCRIPTION OF THE PREFERRED EMBODIMENTS

Embodiments of the present invention will now be described, by way of example only, with reference to the accompanying drawings.

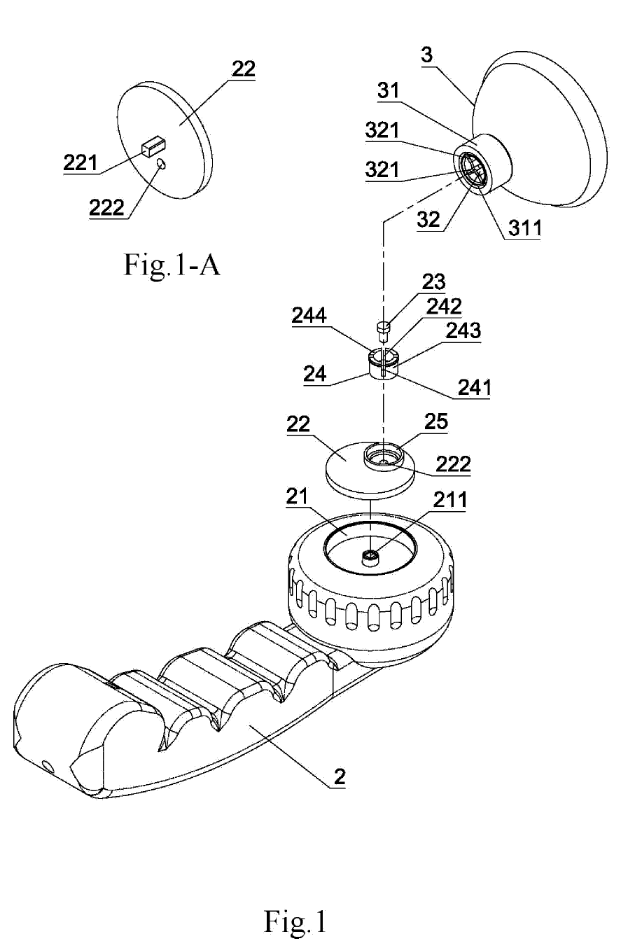

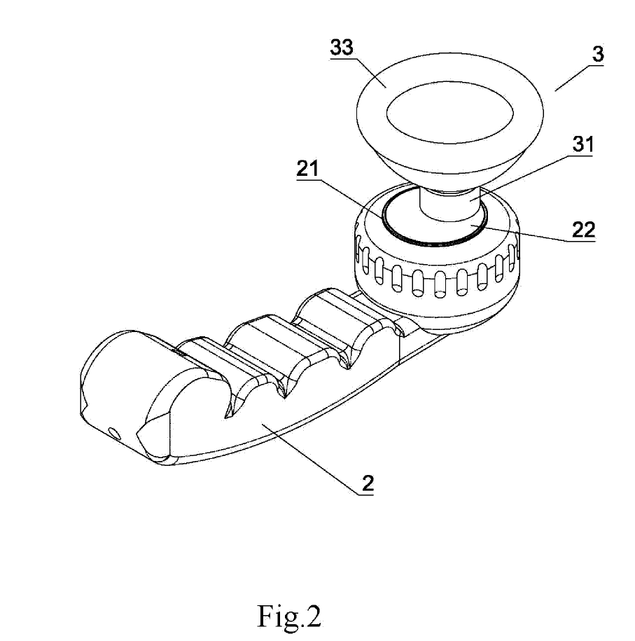

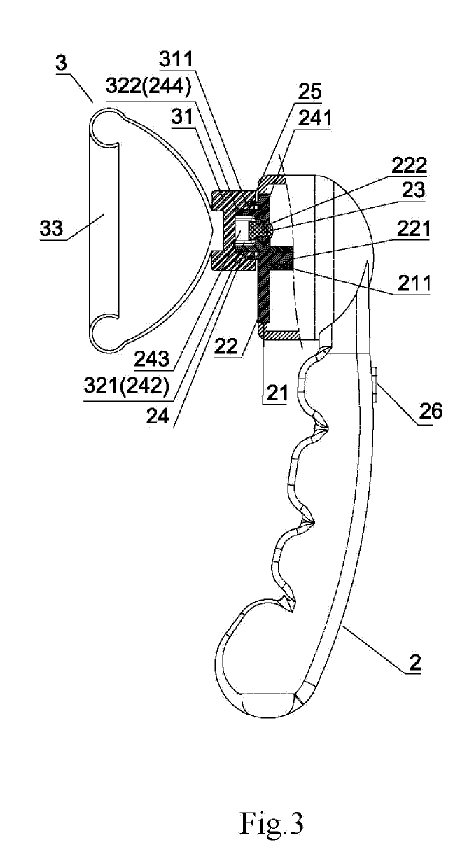

Referring to FIG. 1, FIG. 2, FIG. 3, FIG. 1-A, the massage device of the present invention comprises a rotation member 2 and a massage head seat 3.

The rotation member 2 comprises a driving seat 21 at an upper end thereof.

The driving seat 21 comprises a driving axle 211 which extends from a motor or a gear shaft unit. The driving seat 21 has an opening which faces upward to receive an eccentric rotation disc 22. The eccentric rotation disc 22 has a central axle 221 which is driven by the motor. The eccentric rotation disc 22 further has a hole 222 at a circumferential portion thereof. A rotation post 24 is connected to a top surface of the eccentric rotation disc 22 by means of a rivet 23 which is inserted in a through hole 241 of the rotation post 24. The rotation post 24 has at least two spaced grooves 242 and a resilient section 243 between the two grooves 242. The grooves 242 are formed by cutting an upper portion of the rotation post 24. The resilient section 243 has an engaging rib 244 protruding from an end thereof. The engaging rib 244 is used to engage with a link trough 32 of the massage head seat 3. The eccentric rotation disc 22 further has an annular protection board 25 to surround and protect the rotation post 24.

The massage head seat 3 comprises a link post 31 at one end thereof. The link post 31 has a link trough 32 therein, ribs 321 corresponding to the grooves 242 of the eccentric rotation disc 22, an engaging portion 322 which has a larger diameter to position the engaging rib 244, and an annular groove 311 which is disposed at an edge of the link post 31 and fitted on top of the protection board 25. The massage head seat 3 further comprises a massage surface 33 at another end thereof to massage the neck, chest, waist, abdomen or lymph.

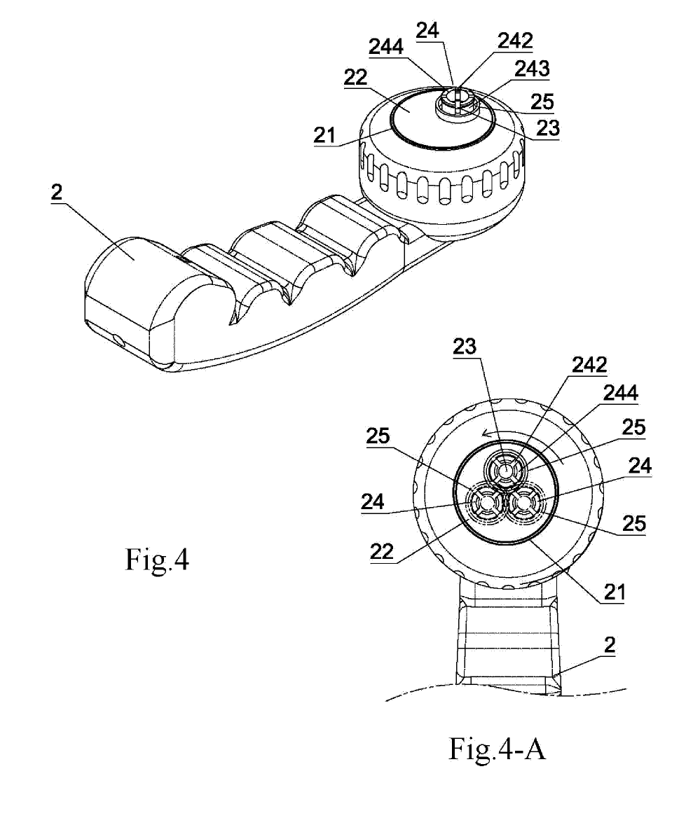

Referring to FIG. 2, FIG. 4, FIG. 4-A, the eccentric rotation disc 22 is connected to the driving axle 211, and the rivet 23 is inserted in the through hole 241 of the rotation post 24 and pivoted to the hole 222. The link post 31 of the massage head seat 3 is pushed toward the rotation post 24, such that the resilient section 243 is pushed inward through the design of the grooves 242 and the engaging rib 244, and the ribs 321 are inserted in the grooves 242. The resilient section 243 will be restored when pushed to the inner edge of the link trough 32, so that the engaging rib 244 is positioned in place and the rotation post 24 is engaged in the link trough 32. The annular groove 311 is fitted on the protection board 25. A press switch 26 is used to control the motor of the rotation member 2. Through the driving axle 211 to drive the axle 221, the eccentric rotation disc 22 is turned to bring eccentric rotation of the massage head seat 3 which is connected with the rotation post 24. The massage surface 33 of the massage head seat 3 is turned to touch the user's body, and its counterforce is counterbalanced by the rotation of the eccentric rotation disc 22 relative to the massage head seat 3. The massage heat seat 3 is turned slowly to provide a comfortable massage effect as a massagist. Through the present invention, the user won't feel pain because of vibration.

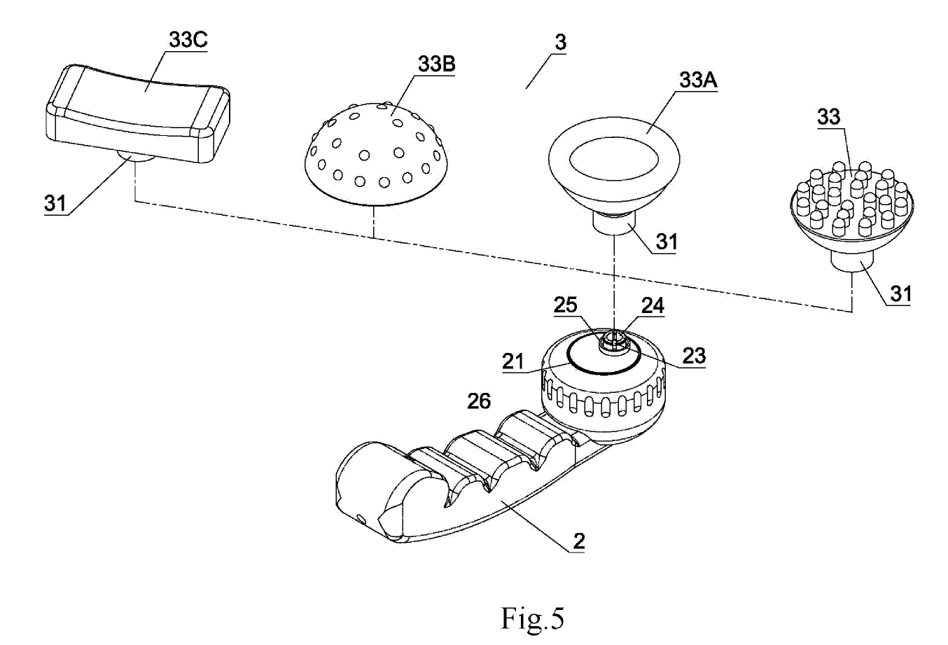

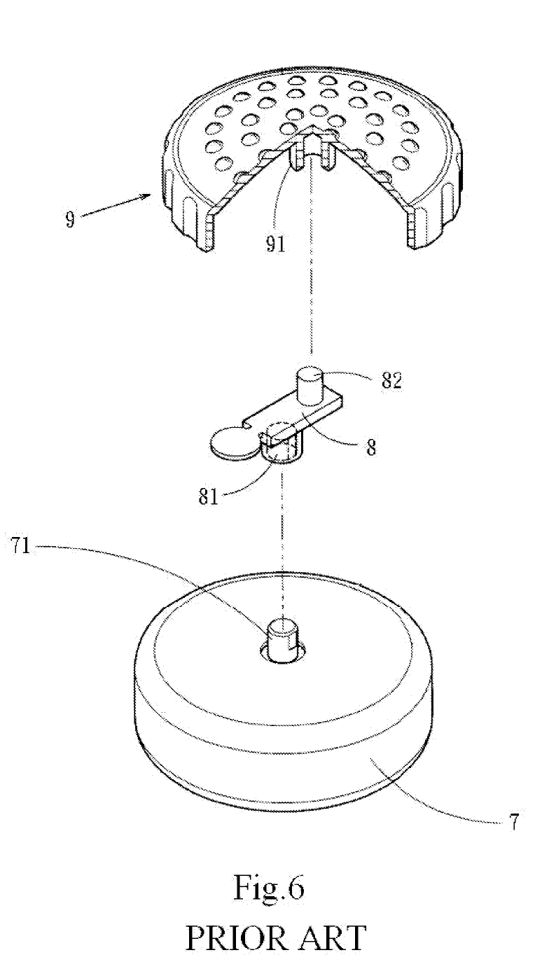

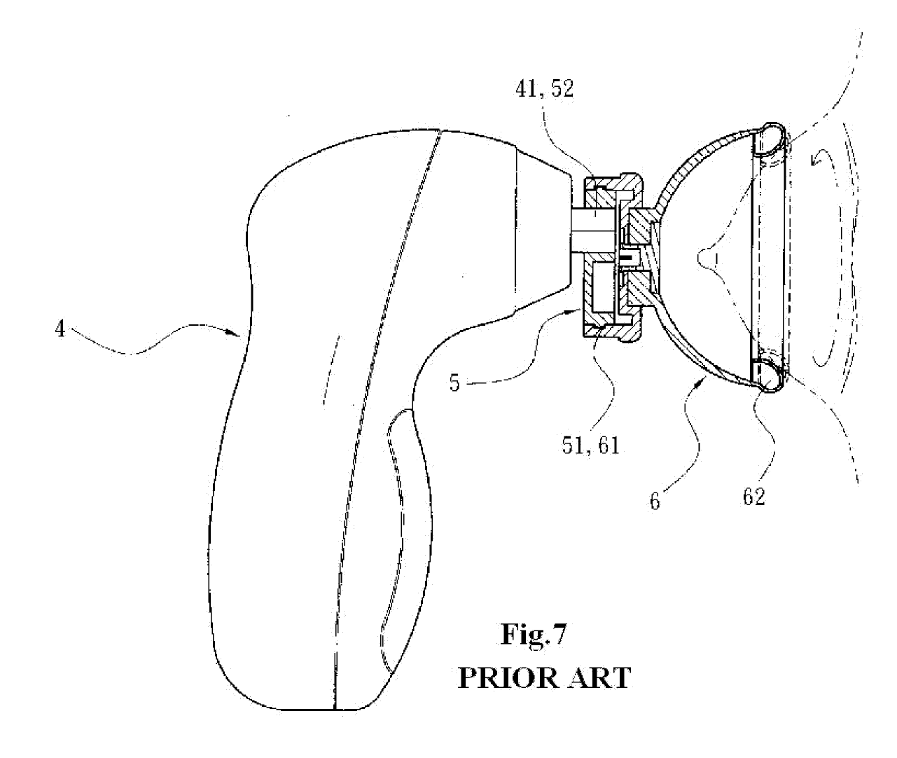

The rotation post 24 is engaged in the link trough 32 of the massage head seat 3 to complete the connection of the eccentric rotation disc 22 and the link post 31, so that the eccentric rotation disc 22 is turned reversely. The annular groove 311 is fitted on top of the protection board 25, preventing the user's hair from being sucked. The rotation post 24 and the link trough 32 can have a larger diameter according to the torsion as desired for massage. The massage surface 33 of the massage head seat 3 can be changed. As shown in FIG. 5, the massage surface 33 is in the form of multiple points, or in the form of a cup 33A for massaging the breast, or in the form of a sponge 33B for massaging the face, or in the form of an elongated concave shape 33C to provide different massage effects.

The present invention provides enough rotation torsion for an eccentric massage effect. The rotation post 24 won't be exposed.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A massage device, comprising a rotation member and a massage head seat, the massage head seat comprising a link post at one end thereof, the link post having a link trough therein and being coupled to a rotation post of the rotation member, the rotation post having at least two spaced grooves and a resilient section between the two grooves, the resilient section having an engaging rib protruding from an end thereof, the link trough having ribs corresponding to the grooves and an engaging portion to position the engaging rib, and characterized by:
the rotation member comprising a driving seat at an upper end thereof, the driving seat comprising a driving axle which extends from a motor disposed in the driving seat, the driving seat having an opening which faces upward to receive an eccentric rotation disc, the eccentric rotation disc having a central axle which is connected to the driving axle of the driving seat, the eccentric rotation disc further having a hole at a circumferential portion thereof, a rivet being inserted in a through hole of the rotation post and pivoted to the hole of the eccentric rotation disc to secure the rotation post at an eccentric position of the eccentric rotation disc;
the massage head seat further having a massage surface at another end thereof;
thereby, the eccentric rotation disc being pivotally connected to the driving seat, the motor driving the eccentric rotation disc to turn through the driving axle so that the rotation post is turned in an eccentric way, the rotation post being pivoted in the hole through the rivet to enhance rotation torsion.

2. The massage device as claimed in claim 1, wherein the eccentric rotation disc further has an annular protection board on a top surface thereof to surround and protect the rotation post, and the link post has an annular groove which is disposed at an edge of the link post and fitted on top of the protection board.

3. The massage device as claimed in claim 1, wherein the rotation post and the link trough each have a large diameter to increase rotation torsion.

4. The massage device as claimed in claim 1, wherein the massage surface of the massage head seat is in the form of multiple points.

5. The massage device as claimed in claim 1, wherein the massage surface of the massage head seat is in the form of a sponge.

6. The massage device as claimed in claim 1, wherein the massage surface of the massage head seat is in the form of an elongated concave.

7. The massage device as claimed in claim 1, wherein the massage surface of the massage head seat is in the form of a cup.
